(19) United States
(12) Patent Application Publication
(10) Pub. No.: US 2005/0278533 A1
(43) Pub. Date: Dec. 15, 2005

(54) System and method for secure communications

(76) Inventor: Yaron Mayer, Jerusalem (IL)

Correspondence Address: YARON MAYER, 21 AHAD HAAM ST., JERUSALEM, 92151, IL

(21) Appl. No.: 10/756,839

(22) Filed: Jan. 11, 2004

Related U.S. Application Data
(60) Provisional application No. 60/452,362, filed on Mar. 3, 2003.
(60) Provisional application No. 60/464,171, filed on Apr. 14, 2003.

(30) Foreign Application Priority Data
Jan. 12, 2003 (IL) 153893
May 3, 2003 (CA) 2,428,628

(51) Int. Cl. H04L 9/00

(52) U.S. Cl. 713/170

(57) ABSTRACT

Like Microsoft's call for trustworthy computing, there are similarly a few inherent problems in communications between computers and/or between other electronic devices (such as for example Fax machines), which can initiate a similar call for trustworthy communications. These problems are caused mainly by various limitations in the currently employed communication protocols, for example over the Internet, or in Fax transmissions. The two main problems are: Verification by the sender that the user indeed received the message, and verification by the receiver that the purported sender indeed is the one who initiated the message. Both of these features are currently lacking for example in normal Fax communications and in normal email communications. In electronic communications over the Internet for example normal email communications allow users very easily to falsify the sender's email address, as happens for example many times when spam (unsolicited junk mail) is sent, or when various viruses, such as for example the Klez worm, spread themselves. A deeper issue in preventing the faking of email addresses is preventing the faking of IP addresses, since, clearly, making sure that the IP address is not forged can help considerably for verifying also the email address. Similarly, when sending normal email messages, the user cannot be sure that the receiver indeed received the message and/or if he/she opened it or read it. Although there are already some solutions to this 2^{nd} problem, these solutions still have various remaining problems, so the problem has not been completely solved yet. The present invention solves the above problems by providing various solutions that preferably include improvement of the protocols and preferably include also methods for preventing theft of digital signatures.

This patent application also claims benefit and priorities from the following US Provisional patent applications, hereby incorporated by reference in their entireties:
60/452,362 of Mar. 2, 2003.
60/464,171 of Apr. 14, 2003

This Patent application claims priority from Israeli application 153893 of Jan. 12, 2003, hereby incorporated by reference in its entirety.

This patent application also claims benefit and priority from Canadian patent application 2,428,628 of May 3, 2003, hereby incorporated by reference in its entirety.

### BACKGROUND OF THE INVENTION

1. Field of the Invention

The present invention relates to communications where data is being transferred, such as for example through the Internet or through Fax communications, and more specifically to a system and method for increased security over such communications, so that the sender can preferably be sure that the receiver received the message and/or at least is able to prove that he indeed sent it, and preferably the receiver for example can be sure that the message indeed originates from the purported sender. Therefore, this preferably includes also for example a system and method for preventing theft of digital signatures and/or forgeries of source addresses on the Internet, such as for example when sending E-Mail.

2. Background

Although Microsoft recently came up with the slogan of trustworthy computing, real comprehensive security in computers requires solving a few deeper inherent problems, as explained for example in another patent application by the present inventor (Israeli patent application 136414 of May 28, 2000, which became later PCT application W00192981). Similarly, there are a few inherent problems in communications between computers and/or between other electronic devices (such as for example Fax machines), which can initiate a similar call for trustworthy communications. These problems are caused mainly by various limitations in the currently employed communication protocols, for example over the Internet, or in Fax transmissions. The two main problems are: Verification by the sender that the user indeed received the message, and verification by the receiver that the purported sender indeed is the one who initiated the message. Both of these features are currently lacking for example in normal Fax communications and in normal email communications.

In Fax communications, for example, unless the receiver can trace the source of the call, the receiver does not know for sure if a Fax transmission indeed originated from the purported sender, or someone for example forged the sender's phone number and/or logo on the head of the Fax. Similarly, unless the sender specifically phones the receiver and requests for example voice confirmation and/or confirmation for example by a return Fax, the sender cannot be sure that the receiver indeed received the Fax or received it properly, or at least cannot prove it in case it is needed later for example in some dispute resolution.

In electronic communications over the Internet, similarly, for example normal email communications allow users very easily to falsify the sender's email address, as happens for example many times when spam (unsolicited junk mail) is sent, or when various viruses, such as for example the Klez worm, spread themselves. This stems from the fact that in E-Mail technology, and Internet technology in general, there are currently no automatic provisions for preventing forgery of source addresses. This allows for example viruses, such as for example the Klez worm, to use for example stolen or fake e-mail addresses in order to pretend coming from other e-mail addresses, thus confusing attempts to track the real sender. For example, there are various incoming-mail server systems that automatically remove this specific Virus when detecting it and also issue a warning to the sender, however, since the sender E-mail address is typically faked by the virus, this message goes to the wrong place (or to nowhere—if the given sender email address doesn't exist at all) and thus has little value and can cause more confusion instead of helping. A similar problem is the fact that spammers (people who send junk e-mail to large groups of irrelevant people that did not ask for it) many times hide behind a bogus e-mail address so that they don't get automatic retaliation by e-mail. An even more severe problem is faking emails from various e-commerce sites, such as for example emails from criminals that can pretend to be for example from eBay, that ask clients for various details and then use that to misuse their accounts there. A deeper issue in preventing the faking of email addresses is preventing the faking of IP addresses, since, clearly, making sure that the IP address is not forged can help considerably for verifying also the email address. Similarly, when sending normal email messages, the user cannot be sure that the receiver indeed received the message and/or if he opened it or read it. Although there are already some solutions to this 2^{nd} problem, these solutions still have various remaining problems, so the problem has not been completely solved yet: There are a number of services today over the internet which offer certified email in a way similar to the way that electronic “greeting multimedia cards” are sent—the message itself is sent to a server, and the receiver gets a notification from the server that a message is waiting for him/her, with a specifically generated URL address, and when the receiver goes to that URL he/she can see the actual message, and the server can confirm that the message has been received. U.S. Pat. No. 6,314,454, issued on Nov. 6, 2001 to Sony corporation defines such a service, although it does not describe precisely how the receiver gets the message from the server. Anyway, this method of delivery still has a number of drawbacks: 1. It is more cumbersome than sending a normal message. 2. If the message is a message that the receiver will probably not like to get, he can always ignore the invitation to view the message or deny that he even received it. U.S. pending application 20020046250 by Nick Nassiri adds the use of a central authority that forwards the message to the actual receiver, and can also keep for example a copy of the content of the message, but it has a number of drawbacks: 1. It does not define how the server itself verifies that the end receiver indeed received the message, so it merely pushes the problem one step forward. 2. It is even more cumbersome, since the sender is required to first access the service site and establish a registration account. Clearly a more straightforward and comprehensive solution is needed.

A related problem is the problem of security when using digital signatures. Recent legislation in the USA regards digital signatures as no less obligating than handwritten signatures, and in other countries there are similar legislations in process. One of the biggest service suppliers in this area even bragged that it could take almost infinite time to break the private keys in these digital signatures, but ignored the simple fact that there is no need to break the keys since it is much easier to steal them, for example by a Trojan horse, which can arrive for example by e-mail or for example through a web page, by exploiting various loopholes in browsers and/or in e-mail programs. Since such a signature can be compelling in any kind of contract, including for example wills and huge real estate deals, and can involve “non-repudiation” even if you prove for example that your computer was compromised by a Trojan horse, it is clear that the damage from stolen keys can be enormous. In fact, a recent article by two leading experts—Carl Ellison and Bruce Schneier—in the Computer Security Journal, Vol. 16, Number 1, 2000 (http://www.counterpane.com/pki-risks.html), shows that the PKI (Public-Key Infrastructure) concept is highly flawed and can expose users to extreme danger. In the above other patent application by the present inventor et. al. (Israeli patent application 136414 of May 28, 2000, which became later PCT application WO0192981), we showed that such private keys are not safe without proper automatic segregation and verification upon accessing the keys and/or the communication channels. In this patent I show an alternative method for securing the private keys based on hardware. The idea of keeping the private keys for digital signatures for example on a separate card is not new in itself, but current cards which only store the keys themselves are still vulnerable for example to Trojan horses that can intercept for example the access to these cards from the computer and/or for example initiate an access of their own after such interception.

### SUMMARY OF THE INVENTION

The present invention solves the above problems by providing various solutions that preferably include improvement of the protocols.

Regarding Fax transmissions, there are a number of possible solutions, so preferably at least one of them is used:
1. In order to ensure the sender's identity in Fax transmissions, one possible solution is that for example the telephone company's computer identifies automatically Fax transmissions and adds its own identification of the originator's phone number to the transmission. This can be done for example by transmitting this number directly to the receiving Fax machine for example as part of the protocol or as additional protocol, so that the receiving Fax machine can understand this number and can for example add it to the header of the Fax. Another possible variation is that the receiving Fax can automatically identify the phone number of the sender (like in identified phone calls, unless for example the sender has blocked it) and preferably can thus automatically add it to the printed Fax. Another possible variation is that this can be added for example by the phone company's computer to the Fax transmission itself, so that it behaves for example like the first few pixel-lines or last few pixel-lines of the Fax transmission or is added or superimposed over some pixel lines such as for example the first or last few original pixel lines, which has the advantage that no special additional protocols or features in Fax machines are needed. (However, this could be problematic if for example an encrypted Fax is sent, since in that case the few added pixel-lines will not be compatible with the encryption—so in this case one possible solution is for example that the phone company adds an additional non-encrypted transmission with the additional data). On the other hand, preferably the sender also has the option of disabling the sender's number identification. However, in such cases preferably the phone company still enforces at least a regional identification—such as for example the real area code of the sender, so that if for example someone forges the logo of another company or organization, at least he cannot do it with an organization that is in another country or area code, because his real area code will show up, and/or in such cases for example the phone company can enforce identifying at least part of the number (such as for example 2 or 3 of the digits, which can be for example the first digits or any other part of the number), so that this does not enable calling back the sender but gives additional identifying details. Another possible variation is that the phone company's computer automatically identifies if the connection is used for a normal voice communication or for Fax transmission, and if it is a Fax or similar kind of transmission preferably the phone company forwards the number to the called number even if the user has normally a block on identified phone calls when he initiates a normal voice call. Of course, various combinations of the above and other variations can also be used.
2. In order to confirm that the receiver indeed received the Fax, one possible solution is that the Fax communications protocol is improved, so that for example each Fax machine automatically sends back a confirmation Fax to the sender if the Fax was received OK, or does it at least if the sender for example requests it for example by setting a “request-confirmation” flag in the sending Fax machine. Of course the confirmation can be sent for example by having the receiving Fax automatically call back the sending Fax, but more preferably the confirmation is done using the same connection that was dialed out by the sending fax, which solves the problem of incurring phone expenses by the receiving fax. The confirmation preferably can include sending back for example one or more or all of the received pages (which is preferably done directly from the receiving Fax's memory, or for example from the hard disk—if the fax machine is for example a fax/modem card in a computer) and/or sending back a serial number of the received Fax (for this preferably each Fax machine has a serial counter which automatically increments by 1 when each Fax is received), and/or sending back for example a digital key, which preferably is based on a unique identifier of the receiving Fax (Preferably a private key), which is preferably converted into another number or numbers, which preferably reflect also the time and the date, preferably in addition to the automatically incrementing serial number, so that it becomes very difficult to be able to fake such a return key. For example, each Fax machine might have one or more unique digital identifier or identifiers (as explained above, preferably a private key) and/or a unique formula for mathematical manipulations on these identifiers as a function of time and date and preferably also of the serial number and preferably also of some identifier of the content. Another possible variation is that the confirmation that the fax was sent and/or that it was received is sent automatically in addition or instead for example by the phone company's computer. Preferably the receiving Fax machine prints the unique confirmation key and/or serial number also on at least one page of the received Fax, so that the receivers also have a good trace of which confirmations were assigned by their fax machine for each message. Another possible variation is that the sending fax also automatically similarly adds is own unique serial number and/or key that preferably reflects also a time and date stamp (for example by some combination of its private key with the time and date), so that the receiver also has a confirmation that the fax sent to him was authentic, for example in case of later dispute. Of course, various combinations of the above and other variations can also be used.
3. Another possible variation is to use for example one or more trusted authorities and send the Fax through such authority, so that the authority itself preferably automatically sends back to the sender a confirmation of the sender and intended receiver and preferably also of the time and date the Fax was sent (and preferably also of the content of the Fax, so that preferably each return confirmation page is stamped by the authority), and also takes care of forwarding the Fax to the intended receiver. The confirmation from the authority to the sender can be done for example by any of the methods described in solution 2 above, and/or for example through email. When forwarding the Fax to the receiver, the intermediate authority can for example use any of the methods described in solution 2 above, or for example, if the receiving Fax machine does not have such features, continue to attempt sending the Fax again at least for a number of times and/or for a certain time, until normal conventional confirmation is received from the receiving machine that the transmission went through OK and/or for example until confirmation according to any of the variations of the above solution 2 is received, and/or until too much time has elapsed and/or too many attempts have failed. The authority then preferably forwards the confirmation also to the sender (again, for example by Fax or by email, for example if provisions for adding email addresses are added for example to the Fax protocol or for example if the user registers there with his number and gives also his/her email), or for example notifies the sender that transmission was unsuccessful, and preferably keeps a record of that also at the trusted authority's archives. This record may include for example also the content of the Fax itself. This way the user can have a 3^{rd} party verified confirmation of the time and date of the transmission, and whether it was successfully also received by the end receiver, and preferably also a confirmation of its content, and the confirmation can be for example in the form of the stamped return Fax, and/or for example in the form of a copy in the authority's database, which can be retrieved upon request also later for example in case of dispute (preferably the copy is kept in the database for at least a few years—for example 7 years). The trusted authority can be for example a government body, such as for example the US postal service and/or for example the phone company itself. Preferably the authority has at least one local branch in each main country so that the fax can be sent to a local number, and preferably the data is then automatically transferred to the branch nearest to the receiver through the Internet. Another possible variation is that the fax machine can be connected to the user's computer in a way that causes it to send the images of the faxed pages directly into the computer so that it can be send directly by email, preferably without having to add a fax card to the computer itself and an additional phone line. This can be done for example by connecting the fax to the parallel port or to the USB and for example adding a function to the fax that allows the user to send the fax-coded images to the computer instead of over phone lines (or for example dialing a special number, such as for example 0 activates this), and then the user can for example send it directly through email to the authority. Of course, like other features of this invention, this feature can be used also independently of any other features of this invention. Of course, various combinations of the above and other variations can also be used.
   Regarding digital signatures, there are a number of possible solutions to ensure that the private keys are not stolen for example by malicious software, so preferably at least one of them is used:
1. In order to ensure the safety of private keys even without a comprehensive generic security system on the computer itself, any separate and preferably detouchable hardware that contains the private keys preferably contains also all the software or firmware for accessing and processing these keys, so that in order to digitally sign and encrypt a document preferably the entire document has to be sent to this hardware and processed by the hardware itself, so the returned output from the hardware is the already encrypted and signed document. This way preferably this hardware is like a black box to any software that can access it from the computer. Preferably the hardware also uses at least one incrementally changing element, which can be affected also for example by the exact time and date, in order to reduce the chance of replay for example by Trojan horses that may intercept the encrypted message. Of course using the hardware preferably requires also typing some, preferably user-chooseable, password or secret number or code, since otherwise the hardware itself might be stolen and used.
2. In addition, preferably any such hardware has a secure and/or encrypted channel for accessing for example the computer screen or the printer or has an output means of its own, in order to display to the user the correct unencrypted document that is being signed. This is important because otherwise a Trojan horse might for example still intercept the connection with the hardware and then send to it for example a dangerous document to be actually processed, while displaying to the user a totally different document which looks innocent to the user. Another possible variation is that the hardware can indicate for example at least the File size and/or CRC and/or other fingerprints of the file that is being signed and preferably some security software and/or for example a function of the Operating system alerts the user if the file that the user sees on the screen has for example a different fingerprint or other parameters than the fingerprint or other parameters shown by the hardware. Another possible variation the user himself has to compare the fingerprint or other parameters displayed by the hardware with the fingerprint or other parameters displayed by the computer, and in such a case preferably there is no access from the computer to the fingerprint, so that for example no malicious software can steal the fingerprint from the hardware and display that on the computer's screen. Another possible variation is to use a security software that ensures that the user always sees the correct real document on which he/she is digitally signing, which can be used for example also if no hardware for the digital keys is used. This is preferably done by preventing any other software from accessing the hardware and/or the driver and/or software that come with the hardware without explicit permission by the user. Of course, this can be also for example, in addition or instead, a feature provided by the Operating system itself.
3. As an additional precaution, in order to prevent for example a Trojan horse from “grabbing” a user's authorization, preferably each authorization can be used only once and must therefore be explicitly reapplied in order to sign an additional document. In other words, if for example the user has to connect the hardware to the computer or for example insert some additional detouchable element within the hardware as an act of signing or for example press his fingertip against a scanner, etc., he/she is preferably required to re-do it again each time a document needs a signature, even if the hardware is called repeatedly for consecutive signings. Of course, various combinations of the above and other variations can also be used.
   Regarding email transmissions there are a number of possible solutions, so preferably at least one of them is used:
1. In order to prevent faking of the sender's email, since many outgoing e-mail servers already use a list or range of acceptable IP addresses for deciding if to relay an e-mail message or not (for example the Hebrew University mail servers refuse to relay e-mail messages sent by users who are currently logged in for example through Netvision, and vice versa), similar principles can be used also according to the source e-mail that the user provides. So for example, each such mail server can look not only at the source IP address but also instead or in addition at the “From” field and/or “reply-to” field of the e-mail message that the user is trying to send and refuse to relay the message if the “From field” indicates an email address who's corresponding IP address is beyond the range or list of allowed IP addresses for that server. Of course, this prevents only faking e-mail addresses which are outside the given organization or area and does not prevent using fake sender addresses that are within the organization. So this can only considerably reduce the problem but does not solve it completely. However, this is a very good heuristic solution and very easy to implement, even without any additional changes in protocols. Of course, various combinations of the above and other variations can also be used.
2. Another possible variation is checking also if the given sender e-mail address actually exists at all—for example by sending a short message to it (Preferably by the 1^{st} email server that receives the outgoing email message) and seeing if there is an acknowledgement or a warning message that there is no such real address. This can be done for example within the organization and/or also with e-mail addresses that are outside the organization, by checking the response of the appropriate remote e-mail server. Of course, various combinations of the above and other variations can also be used.
3. Another possible variation could be a change in the e-mail protocol, so that for example each e-mail-sending program must use some random code and/or preferably also for example the exact time in milliseconds when the message was generated, and the email server immediately contacts back the sender and asks it to repeat the sent code and refuses to relay an e-mail message if the sender does not respond with the correct answer. This way, if a fake sender address has been used, the sending programs there will not be able to respond with the correct code. However, this solution is more cumbersome, and also is impractical since in most cases where people use e-mail today, they are connected to the Internet for example via a dial-up connection or an ADSL connection, which can change each time they make a new connection, and thus the sender e-mail address that they use is typically some logical address on the incoming mail server of their access provider. Thus the source e-mail address that they use is by definition typically not identical with the identity of the real sending machine. So this stringent method could work only for example when people send e-mail messages through a University mainframe, in which case the sender e-mail address is indeed identical with the sending computer. However, this or similar principles can be used for example for making sure that the user does not use a fake IP address and for similarly preventing malicious programs (such as for example various viruses or worms or Trojan horses) from pretending to be themselves a relaying e-mail server instead of an e-mail client program. Therefore, such a solution, applied to IP addresses, can be used for example in combination with solution no. 1. (Another possible variation is that whenever the user sends an email message the appropriate incoming mail server is automatically informed about it and thus can respond to the challenge and preferably for example the ISP automatically allows this only to users who are indeed allowed to access it, and/or for example the ISP automatically adds to each outgoing message the defined incoming-mail server, however such a solution is more cumbersome and creates unnecessary limitations on the user). Another possible variation is that the ISP for example automatically adds the user's real assigned IP address and/or the confirmed user identity preferably to all outgoing packets or for example at least to emails. Of course, various combinations of the above and other variations can also be used.
4. Another possible variation, which can further help implement for example solutions 1 and 3, can be used in the future IP structure where physical (geographical) IP addresses are used. In a physical address system each server can instantly know if any IP address given by the user is real or not according the trace of its route, and thus refuse to communicate with a source that uses an IP address that is impossible according to its real position on the Internet. For this, preferably each relay server or router preferably adds its own IP address to each packet as it travels though it. Of course, various combinations of the above and other variations can also be used.
5. Another possible variation that can further solve the problem of using a bogus sender e-mail address that belongs to someone else within the organization is that preferably the access provider and/or the e-mail server require the user to list for example up to 3 phone numbers (or any other preferably small reasonable or limited number of allowed phone numbers) which can be used by him/her when connecting to the Internet through that access provider, and preferably when making the connection the phone company automatically provides the access provider with the correct phone number used by the user, and the access provider's server then preferably automatically records the actual phone-number and the IP address assigned for that connection and for example makes sure what e-mails are associated with that phone number. This way if for example a malicious program on the user's computer then tries to access the Internet with a false IP address, the access provider's servers can immediately find that the IP address does not fit the real IP address assigned to that connection and preferably for example block all such packets which contain the falsified IP address and/or log the case and/or notify the access provider's authority, etc. For enforcing this, preferably the phone company's computer automatically identifies if the connection is used for a normal voice communication or for electronic data connection (including if it is for example ADSL or cable TV connection to the internet, etc.) and if it is a data connection preferably the phone company forwards the number to the ISP even if the user has normally a block on identified phone calls when he initiates a normal voice call. This is very important since many computer crimes are committed from stolen accounts. Another possible variation is that, if the phone company cannot provide this service, the user himself has to provide the number used each time (This is less reliable, however in combination with the above solutions it can still achieve good results). Another possible variation is that for example some unique identifier of the user's computer and/or for example of its communication card is used preferably by the ISP as the unique identifier instead of or in addition to the actual phone number, for example in a way similar to using such unique identification during secure http (https://), except that the identifiers are preferably saved by the ISP also between sessions. This method can be used also in case of connecting to the Internet from mobile devices, such as for example mobile phones or palm computers or portable computers. If the user changes the device from which he communicates with the Internet or changes for example the communications device in it, then preferably he has to explicitly inform his ISP about this and authorize the change. Of course this can be used also for preventing the use of stolen accounts and/or passwords. This way, for example the nearest end-node of the access provider always knows if the IP address used by the software on the User's machine is indeed the correct one assigned to it by the access provider. Within large organizations where users work for example from within a large building, this phone method can also be used, and/or for example any other physical address or fingerprint identifying the machine and/or the specific network connection used. This itself can ensure only that IP addresses are not faked, which can be also very useful for example in cases of DDOS (Distributed Denial of Service) attacks, so that the attacked server or its firewall can immediately start dropping packets arriving from the attacking IP addresses, since otherwise an attacking Trojan horse could for example change a faked IP address all the time. This does not by itself prevent faking of email addresses within the organization or within the valid range of IP addresses of the access provider, but it allows for example very easily tracing the user who's computer generated a false email address if it is later determined to be false for example by the receiver of the message. Another possible variation is that each user is allowed by the access provider for example to explicitly provide a list of allowed sender email addresses that can be used from each uniquely identified computer and/or connection and/or phone numbers. Another possible variation is that each time a user's computer sends an email address or uses some IP address it is logged on the nearest access provider's node along with unique identifying data of the computer and/or the connection and/or for example the phone number used and/or the IP address that was assigned to this connection, and if the sender email address changes more than a certain allowed number of times during that session then for example messages with additional sender email addresses are for example blocked and/or the case is logged and/or reported to for example to the access provider authority. (Another possible variation is to do the same also for IP address changes, but as explained above preferably attempts to use the wrong IP address are automatically blocked). Of course various combinations of the above and other variations can also be used.
6. Another possible variation for preventing faking of source IP addresses is that the first server or node (preferably of the access provider) that the outgoing packets from the user's computer reaches first sends back a short package to the given source IP address and forwards the packets only if the machine at the given IP address confirms that it indeed initiated the outgoing packets. Preferably such confirmation is based on replying to a unique challenge so that only the real originator can respond. However, a malicious program could circumvent such checks for example by pretending to be another server or router or for example an email server. But, since in normal email protocol typically the sending mail server connects directly to the receiving mail server at the domain of the target address without going through other mail servers on the way (so there are typically only routers on the way that relay the packets)—preferably the mail server on the receiver's side verifies the IP of the sender's side server by contacting back the sender's side mail server, preferably with a challenge so that only the real originator can respond, and thus even if the sending client can pretend to be a server, it doesn't help him since attempts to fake the IP address will not work. Another possible variation is for example to perform this check also between at least some nodes on the way, but that would be less efficient. Another possible variation is that normal users that are not running servers are automatically marked by the access provider as end-node and thus attempts to pretend to be a server can be automatically ignored. This is very easy to accomplish since most access providers for example in Israel do not allow normal users to run servers. Another possible variation is that the access provider identifies if someone runs a real server for example according to its behavior. Another possible variation is that there are also for example one or more email authorities (for example in a way similar to phone companies) in which users can or have to register in order to confirm who they really are and that they are indeed the one who are using that email addresses. Of course various combinations of the above and other variations can also be used.
7. Another problem is the fact that when people connect to the Internet for example from an Internet Café, many times they forget to close down open connections and/or at least they leave behind traces such as for example various cookie files, temporary files, history logs, etc. There have already been cases that users who subsequently used the same computer misused this for example to send a false suicide note or to send a false kidnapping message, etc. Although some web based email sites, such as for example Hotmail and Yahoo, allow the user to mark when he/she is using a public computer, this relies on the user marking it and is anyway just a limited solution. Therefore, preferably the OS itself, preferably during installation, enables the administrator to specify that this is a public-use computer, and preferably this setting can be changed only for example with the original installation disk and/or with a password and/or with some other physical key. Preferably when defined as a public computer, the OS itself indicates this in outgoing electronic communications such as for example emails, for example by adding this info at the socket layer, and preferably any session-related traces are automatically removed by the system for example after a short time of inactivity and/or if the user does not re-enter a password chosen by the original person that started the session, or for example such traces are not saved at all. Another possible variation is that in addition for example the OS allows the user to send additional email messages from the same session only if he/she know the password entered or chosen by the user when he/she started the session, etc. Another possible variation is that this is enforced for example instead or in addition by a security software that is installed on the computer.
8. In order to enable delivery confirmation of email messages, one possible variation is to use one or more trusted authorities like in solution 3 for Fax transmissions. The additional advantage of this is there can be an independent confirmation also of the content of the message, a feature which is lacking even in normal certified mail. This confirmation can be, again, for example in the form of a certified copy returned from the authority, for example with various stamps or signatures, and/or in the form of a record kept at the authority for example for 7 years, in case a later certificate is needed. However, preferably no previous setting of account by the sender at the server is required, and each sender can preferably automatically use the services of the trusted authority by simply using a properly formed message. This is explained in more detail in the reference to FIG. 1. Of course, various combinations of the above and other variations can also be used.
9. Another possible variation in order to confirm that the receiver indeed received an email message, is that the email communications protocol is improved, so that for example each end-node email server that communicates directly with the final receiver (typically this is the mail server at the domain of the receiver's email address) preferably automatically sends back a confirmation to the sender and/or to the mail server at the sender's side if the email was received OK, or does it at least if the sender for example requests it for example by setting a “request-confirmation” flag in the sent email message. The confirmation that the message was received OK by the receiving server can be for example by the aid of sending also at least one CRC or fingerprint or size data together with the message from the sending server, so that the receiving server can confirm that the message came OK, and/or for example the receiving server also sends back to the sending server a copy of the message it received, so that the sending server can check if it is identical with the sent message. Preferably the copy is sent back with a digital stamp and serial number, like in the case of using a trusted authority. In the existing prior art protocol, the sending server only knows if it succeeded to connect to the receiving server and if the requested address there exists, but not if the message itself was received completely, etc. Another possible variation is that the mail server at the side of the receiver preferably also automatically informs the mail server at the side of the sender and/or the sender directly if and when the receiver's client program actually downloads the message from the mail server at the side of the receiver. This feature is also not done in the prior art. This is explained in more detail in the reference to FIG. 2. Of course, various combinations of the above and other variations can also be used.
10. Another problem is that many times a messages is received but is simply lost because the user does not notice it among all the dozens of junk emails that most users get each day, which can happen for example if the sender uses a subject that looks somewhat similar to a typical subject of junk mail. In order to prevent this preferably the user can instruct the receiving server and/or for example his email client to mark more conspicuously and/or put in a separate group or list all the emails from a list of senders which the user marks as preferred. Another possible variation is that this group can be generated also, instead or in addition, automatically for example by the email client program and/or for example by the closest email server, for example by putting in the list all the emails to which the user himself sent messages and/or giving them for example a higher position if the user sent more messages to them, and thus automatically messages from email addresses with which the user has already communicated receive automatically higher emphasis than any incoming messages from sources to which the user never sent an outgoing email message or reply. Another possible variation is that the user can for example create similarly a list of email addresses from which he wishes messages to be put in a separate list of suspected junk mails or less important emails or for example to be automatically ignored or deleted, which is of course much more useful in combination with any of the above methods for preventing faking of the sender addresses. Another possible variation is that the sending server keeps a record of messages that were sent out (at least for example subject, sender and receiver) at least for a certain period, and the receiving server and/or the user's client email program can preferably be instructed by the user for example to check once in a while if and when any messages were sent from a certain sender (or list of senders) to the user. This way, for example if the user considers it very important that he does not miss any messages from the USPTO, he can instruct for example the receiving server or his email client to query for example once a week or once a month or once a day the email server (or servers) of the USPTO to download a list of all the messages that were sent to the user, and thus find out if there were any missed messages. If the sending server keeps also the message itself at least for a while then preferably the user can request its automatic resending, otherwise at least he knows that an email was lost and can request it again from the sender itself. Of course, various combinations of the above and other variations can also be used.

Of course, various combinations of the above and other variations can also be used, both within the solutions and across them. On the other hand, many times users have a legitimate need to use a constant or official e-mail address in which they want to use as their representative e-mail address even when actually sending the message from another source. For example they might be sending e-mail from home but they want the sender address to be the address on their Internet site's server (for example using the domain of their site). Therefore, the above solutions must not interfere with this legitimate need. There are a number of possible solutions to this problem, so preferably at least one of them is used:
1. The sender can use any official sender and/or “reply-to” e-mail address that he wishes, but preferably he/she must include also an additional field which shows the correct e-mail address which was actually used during the sending of the message. (This field can be called for example “sent-via:”, or any other suitable name).
2. The mail server on the user's site allows legitimate users (for example if they have the correct login and password to access it) to define various e-mails and/or IP addresses that they might use when actually sending the messages, and in order to enable this, for example if the outgoing mail server finds that the sender address is not within the allowed range, it can still relay the message for example if it queries the server at the user's site and the server confirms that the actual sender address is listed there.
   Of course, various combinations of the above and other variations can also be used, both within the solutions and across them. Of course, the above principles are not limited only to e-mail messages, but can be used also for example for preventing using telnet from fake IP addresses, or for example for preventing using digital signatures from IP addresses that are outside a range or list of allowed IP addresses, for example as supplied by the owner of the digital signature. This way, for example, no one can use a stolen digital signature from another place. Preferably in all of the solutions where a confirmation is sent back to the user by a trusted authority or by servers along the way, the party that sends the confirmation preferably also confirms for example by any of the above methods that the sender indeed received the confirmation or at least is able to send again the confirmation if the sender requests it.

Also, the above solutions can still allow people to use anonymous addresses by using for example the e-mail services of public sites that allow anyone to open an e-mail box online and send e-mails from there, such as for example hotmail.com or yahoo.com, except that at least some of the above solutions can also be used to enforce that an email sent for example from user1@hotmail.com will not use as the sender field the fake email address of for example user2@hotmail.com or any other e-mail address outside that system.

Another possible variation is to create various combinations with conventional postal services, such as for example certified mail based on leaving only “the last miles” to hand-delivery. This way, for example, preferably the certified email message or Fax is automatically relayed for example to a post-office branch which is near or nearest to the receiver's Physical address, and is printed and hand-delivered from there like an ordinary certified mail, except that the whole process can be of course much faster than ordinary certified mail. This is preferably used in combination with IP addresses that contain also physical addresses, preferably based on a Hierarchy, as explained for example in U.S. patent application Ser. No. 10/375,208 of Feb. 17, 2003, by the present inventor. However, until such physical IP addresses are implemented, preferably matching is automatically done for example by using the physical address of the receiver and automatically matching it with the near post office branch, for example by a combination of country, city and zip code.

Another possible variation is using various combinations between Fax and email messages, so that for example certified communication can be sent to the trusted authority for example as email messages and converted there to Fax communications with the receiver, and/or for example certified communications can be sent to the trusted authority for example as Fax messages and converted there for example to email communications with the receiver, etc.

Of course various combinations of the above and other solutions can also be used. Some of above receipt-verification features may be used for example if the user specifically requests certified communications, or for example automatically even without requesting it, or for example automatically for basic verification and based on user request for more intensive verification, so that for example the basic verification is sending back from the last server or router or node that communicates directly with the receiver at least a confirmation serial number and/or time and date stamp and/or digital key (that preferably contains also the time and date and serial number of the message and some unique identifier of the server).

### BRIEF DESCRIPTION OF THE DRAWINGS

FIG. 1 is an illustration of a preferable example of a configuration using a trusted authority for verifying the receipt and preferably also the content of an email or fax message.

FIG. 2 is an illustration of a preferable example of using for example mail servers or routers along the way for verifying the receipt and preferably also the content of an email or fax message.

### IMPORTANT CLARIFICATION AND GLOSSARY

All these drawings are just or exemplary drawings. They should not be interpreted as literal positioning, shapes, angles, or sizes of the various elements. Throughout the patent whenever variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. SMTP stands for Simple Mail Transport Protocol. MIME stands for Multipurpose Internet Mail Extensions. Typically email is sent between email servers through SMTP or MIME protocols, and the connection between the receiver's client program and the receiving email server is typically through POP protocol, which stands for Post Office Protocol. Throughout the patent, including the claims, “mail server” or “email server” means a server that sends or receives email messages. “Email” is the standard term for electronic messages, although in the future it might include for example also photonic messages if the computers and communications become all-optical. ISP stands for Internet Service Provider, which means the companies that provide the users with physical access to the Internet.

### DETAILED DESCRIPTION OF THE PREFERRED EMBODIMENTS

All of descriptions in this and other sections are intended to be illustrative examples and not limiting.

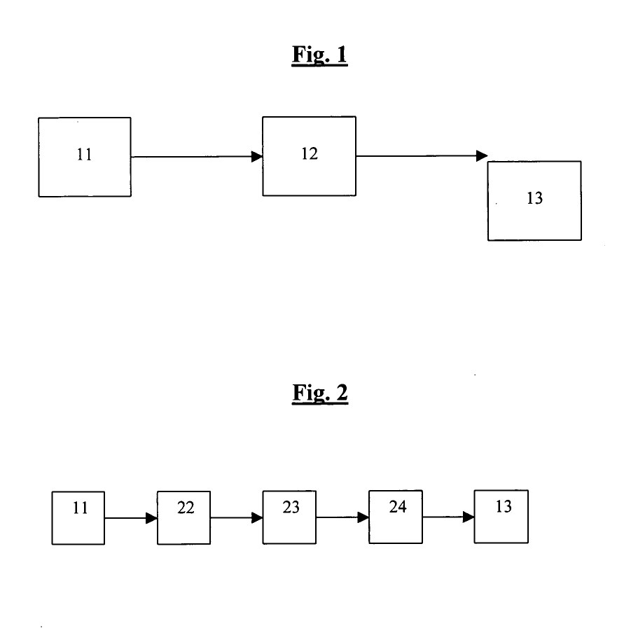

Referring to FIG. 1, I show a preferable example of a configuration using a trusted authority for verifying the receipt and preferably also the content of an email or fax message. The email message from the user's computer (11) goes through the trusted authority (12) on the way to the receiver's computer (13). The additional advantage of this is there can be an independent confirmation also of the content of the message, a feature which is lacking even in normal certified mail. As explained in the patent summary, this confirmation can be for example in the form of a certified copy returned from the authority, for example with various stamps or signature, and/or in the form of a record kept at the authority for example for 7 years, in case a later certificate is needed. The confirmation itself can be sent for example by a stamped return FAX or digitally signed email. However, preferably no previous setting of account by the sender at the server is required, and each sender can preferably automatically use the services of the trusted authority for example by simply using a properly formed message. The authority itself preferably automatically sends back to the sender a confirmation of the time and date the email was sent (and preferably also of the content of the email, so that preferably the return confirmation email is digitally signed by the authority), and also takes care of forwarding the email to the intended receiver. When forwarding the email to the receiver, the intermediate authority can for example use any of the methods described in this invention to verify that the receiver indeed receives the message, and, if the receiver has not received it, preferably continues to attempt sending the message again at least for a number of times and/or for a certain time, for example until confirmation according to any of the above variations is received, and/or until too much time has elapsed and/or too many attempts have failed. The authority then preferably forwards the confirmation also to the sender, or for example notifies the sender that transmission was unsuccessful, and preferably keeps a record of that also at the trusted authority's archives. Another possible variation is that the trusted authority delivers the message to the user by the “greeting card” method described above, or for example tries to use the “greeting card” method only if normal confirmation (for example by any of the other methods described in this invention) is not received for example within a certain time and/or after a certain number of attempts to resend the message. The confirmation record may include for example also the content of the email itself. This way the user can have a 3^{rd} party verified confirmation of the time and date of the message, and whether it was successfully also received by the end receiver, and preferably also a confirmation of its content, and the confirmation can be for example in the form a stamped return Fax and/or digitally signed return copy of the sent email message, and/or for example in the form of a copy in the authority's database, which can be retrieved upon request also later for example in case of dispute. Another possible variation is that the authority saves for example one or more CRCs and/or other types of fingerprints of the message that can be used for proving what the content was, without having to save the full content itself, which can thus save a lot of space on the authority's database. Another possible variation is that the authority for example charges a smaller amount for saving only the CRC's (and/or other fingerprints of the content) and a larger amount for saving the full content (and/or charges for example depending on the size of the content that has to be saved). The trusted authority can be for example a government body, such as for example the US postal service and/or for example any online legal or trusted authority. Preferably payments for the authority's services can be done for example by adding an appropriate header (or other element or part) to the message, so that no special account-setting is needed for that, such as for example by giving preferably encrypted credit card info, or paying for example by small micro-payments credit points, for example by automatically adding it directly to the regular ISP bill, or for example payment can be done later when the authority gets back to the sender. Also, preferably the email protocol is improved to allow secure email that preferably contains unique parameters of the sender's computer or connection, which are preferably sent encrypted in a way similar to a secure access to a web page (https:// . . . ), or for example S/MIME is used, which already does something similar. This is preferably done by creating some bi-directional link between the sending computer and the receiving mail server. Of course, various combinations of the above and other variations can also be used.

Referring to FIG. 2, I show a preferable example of using for example mail servers and/or routers and/or other types of nodes along the way for verifying the receipt and preferably also the content of an email or fax message. In this example for example various email servers and/or routers (22-24) between the user's computer (11) and the receiver's computer (13) can be used for verifying the receipt. Preferably the email communications protocol is improved, so that for example the end-node email server or router (24) that communicates directly with the final receiver (13) (typically this is the mail server at the domain of the receiver's email address) preferably automatically sends back a confirmation email to the sender and/or to the mail server at the side of the sender (11) if the email was received OK, or does it at least if the sender for example requests it, for example by setting a “request-confirmation” flag in the sent email message. The confirmation preferably can include sending back for example a digitally certified copy of the email message and/or at least part of it and/or sending back for example some serial number of the message preferably with a time and date stamp and/or a digital key, which preferably is based on a unique identifier of the server or router (for example some private encryption key), which is preferably converted into another number or numbers, which preferably reflect also the time and the date and preferably also the serial number of the message, so that it becomes very difficult to be able to fake such a return key. For example, each server might have one or more unique digital identifier or identifiers and/or private encryption key and/or a unique formula for mathematical manipulations on these identifiers as a function of time and date. Another possible variation is that the return key includes for example also identifiers for the content, such as for example one or more CRCs and/or fingerprints that can be used for confirming that what the content was. Another possible variation is that the server can for example save a copy of this CRC or CRCs or fingerprints at least upon request for example for at least a certain time period. Preferably for example the unique private key of the server prevents forgery of the receipt, so that knowing the secret key is required in order to be able to create the proper receipt at the given time and date and preferably with the correct fingerprints. This can prevent the need for keeping a log of these confirmations on the mail server. Another possible variation is to keep a log anyway, preferably with the serial number of each message, at least for a certain period, in order to even further reduce the risk of forgery and in order to enable the sender to request a copy of the confirmation also at a later time, for example in case of dispute. However, since preferably only fingerprints of the content of the message have to be saved in this log and not necessarily the entire message, this does not take too much space on the server. Another possible variation is the sending email server similarly also adds its own confirmation key and/or time and date stamps and/or serial number, so that these can be used by the receiver as a confirmation about the content of the message that was sent to him for example in case of later dispute. Preferably the mail servers and any trusted authorities are protected by a powerful security system that prevents hackers from breaking into them and stealing for example their private keys or tempering with their logs, such as for example the security system described in the above Israeli patent application 136414 of May 28, 2000, which later became PCT application WO0192981. Preferably the logs of these servers and similarly of the servers of a trusted authority, if such authority is used, are also constantly or regularly, preferably automatically and incrementally, backed up offline, so that even if hackers succeed to break into the server they cannot temper with the offline records. Another possible variation is to use a similar confirmation for example also from relay mail servers or routers or other types of nodes or servers along the way and not only the last one, except that preferably in this case only confirmation keys are sent along the way and preferably at most only one return certified copy of the email is sent back to the sender. However, this is typically unnecessary, since usually the mail server on the side of the sender connects directly to the mail server on the side of the receiver, without any intermediate mail servers, with only routers that forward the packets along the way. Another possible variation is for example to change the email protocol so that for example the last server or router that communicates directly with the receiver can query or always queries the receiving end-node after sending the message, and the receiving end-node either answers that it received it or that it didn't, and preferably if no answer is received, the last sending node keeps trying at least for a certain number of times and/or a certain period. Another possible variation is that the original server of the sender or any other server along the way can send the request for acknowledgement to the receiving node and wait for the confirmation. Preferably the acknowledgement also contains some unique identifier and serial number of the message and some manipulation on the time and sate stamp. Another possible variation is that the mail server at the side of the receiver preferably also automatically informs for example the mail server at the side of the sender and/or the sender directly for example when the receiver's client program actually downloads the message from the mail server at the side of the receiver. Another possible variation is that either the trusted authority, if such an authority is used, or for example the final server before the receiving node (typically this is the mail server at the domain of the receiver's email address) or for example the sending mail server, preferably encrypts the mail and sends in to the receiver so that the receiver gets a “Closed envelope”. When the receiver wants to read the message, preferably the email client program automatically downloads an opening key from the relevant server, and this way the server can know for sure that the message has been read and can send back the confirmation to the sender. This way the message itself does not have to be saved in the server (or for example on the trusted authority's server if a trusted authority is used), and the receiver does not have to go explicitly to receive the email from some server, unlike the “greeting card method”. Although this encryption can also be done in addition or instead for example by the receiving mail server, preferably it is done by the sending mail server, which has the further advantage that the message is encrypted on the way between the sending server to the receiving server, thus guarding it also from tempering along the way between them. However, as explained above in other variations, preferably the server saves at least also one or more fingerprints of the content and can send it back to the sender for example upon request and/or automatically as part of the serial confirmation code. Another possible variation is that the receiving email client automatically downloads the key from the relevant server as soon as the message is received without waiting for the user to request to open the message, which has the advantage that the user can for example first download all the messages and then read them offline. Another possible variation is more generally that the email protocol is changed so that the receiving mail server has to send some kind of acknowledgement to the sending server any time during the transmission of a message before the transmission is considered complete, such as for example at the beginning, in the middle, and/or in the end, and if it is not received preferably the server continues to try to send it at least a certain number of times or for a certain period. Preferably at least two confirmations can be sent: One when the message is received by the receiving mail server, and the other when the user opens the message for reading. Another possible variation is that the mail server at the side of the receiver preferably also automatically informs the mail server at the side of the sender and/or the sender directly when the receiver's client program actually downloads the message from the mail server at the side of the receiver. Preferably the sender and/or the sending server can also query the receiving mail server if the message has been downloaded by the receiver's client program, for example in case this notification has not reached the sender because of some error along the way. This is another reason why preferably a log is also kept on the receiving server, since otherwise if for example the server keeps new mail messages for only two months, without a log which is preferably kept for longer times, after two months the receiving server might not know if a deleted messages was deleted because the client downloaded it or because it expired. If the mail server is for example on a Unix machine or on a mainframe computer and the sender gets the mail for example directly through logging-in, for example through telnet, then preferably the receiving mail server informs the sender and/or the sending mail server that the message has been forwarded to the receiver at the moment that the servers adds the message to the user's messages Box, and preferably the software that allows the user to later access the message preferably also sends a confirmation to the server when the user actually opens the mail message. Preferably this is done with a resident software or driver that ensures that the server is informed whenever the message is accessed, so that tempering with the client software cannot prevent notifying the server. Similarly, if the mail is for example on a mailbox web service, such as for example yahoo.com or hotmail.com, then preferably the receiving mail server informs the sender and/or the sending server that the message has been received as soon as it stores the message at the appropriate mailbox, and preferably when the receiver accesses the server and opens the message, the server preferably automatically sends another message to the sender, confirming that the message has been read. In these cases too preferably the sender can also query the server at least for a certain period to find if the message has already been opened or not. Another possible variation is that in any of the above variations there is also another type of indication—if the user saw the header of the message, even if he didn't open it, which is preferably also sent to the sender and/or to the sending mail server. This additional indication can be done for example by the software that allows the user to access the messages, or for example different opening keys are needed for the header and for the content of the message. Another possible variation is that the sending mail server and/or the receiving mail server automatically add an HTML code to the message that when executed makes the client mail program immediately connect to some address on the mail server, thus automatically confirming that the message has been opened. Using such an HTML link in the message that connects to some intermediary 3^{rd} party's server along the way has been used already as an email-tracing method. However that is less convenient since in that case the user has to send the message in coordination with some third party. The preset variation is better since it makes this an internal element in the mail protocol, preferably using automatically at least the sender's side mail server and/or the receiver's side mail server. The above features for confirming receipt of the mail or at least some of them can be for example applied automatically for any email, or for example applied only if the user marks the message as “certified email”. If payment is required for certified email, then preferably this is in the form of micro-payments, preferably charged directly from the sender's ISP, or for example the ISP charges just a little more for ISP services that allow using certified email and thus enables free use of certified email for example to users that are subscribed to it. Of course when the message is sent through a trusted authority, the authority can also similarly use any of the above methods to ensure that the receiver has indeed received the message. Another possible variation is that a copy of the message is sent in parallel also to a trusted authority for example for keeping a full log of the content without the need to route the message through the authority, if any of the above methods are used to sufficiently ensure that the message indeed has been received by the receiver. Of course, various combinations of the above and other variations can also be used.

While the invention has been described with respect to a limited number of embodiments, it will be appreciated that many variations, modifications, expansions and other applications of the invention may be made which are included within the scope of the present invention, as would be obvious to those skilled in the art.

1. A system for secure data communications in at least one of Fax transmissions and computer network communications, comprising at least one of:
a. A system that allows the sender to get a confirmation that the receiver received the message without having to rely on the receiver accessing a web site for reading the message.
b. A system that enables the sender to prove that he indeed sent the message to the intended receiver at the specified time and date.
c. A system that enables the sender to prove the content of the message that was sent.
d. A system that enables the receiver to know that the message indeed originates from the purported sender without the need to rely on encryption and digital signatures.
e. A system for preventing the theft of digital signatures based on a hardware that contains not only the encryption keys but also a surrounding processing in isolation so that malicious software cannot cheat the users by accessing said hardware.
f. A system for preventing forgeries of source addresses of the senders of the messages which is applied to at least one of: the sender's phone number, the sender's email addresses, and the sender's IP addresses.

2. The system of claim 1 wherein said communications are Fax transmissions, and at least one of the following features exists:
a. The telephone company's computer identifies automatically Fax transmissions and adds its own identification of the originator's phone number to the transmission.
b. The telephone company's computer identifies automatically Fax transmissions and adds its own identification of the originator's phone number to the transmission, and said identification of the sender's phone number is transmitted directly to the receiving Fax machine by at least one of: 1. As part of the protocol or as additional protocol, so that the receiving Fax machine can understand this number and can itself add it to the Fax; 2. The phone company's computer adds it to the Fax transmission itself, so that it behaves like the first few pixel-lines or last few pixel-lines of the Fax transmission or is superimposed over any of the original pixel lines; 3. The receiving Fax can automatically identify the phone number of the sender like in identified phone calls, and can thus automatically add it to the printed Fax.
c. The sender has the option of disabling the sender's number identification.
d. If the sender disables phone number identification, the phone company still enforces at least a regional identification.
e. The confirmation that the fax was sent and/or that it was received is sent automatically by the phone company's computer.

3. (canceled)

4. The system of claim 1 wherein said communications are Fax transmission and in order to confirm that the receiver indeed received the Fax, each Fax machine automatically sends back a confirmation Fax to the sender if the Fax was received OK, or does it at least if the sender requests it, and wherein said confirmation includes at least one of:
a. Sending back a copy of one or more or all of the received pages.
b. Sending back a serial number of the received Fax.
c. Sending back a digital key
d. Sending back a digital key based on a unique identifier of the receiving Fax and at least one of the time and date, the serial number of the message, and some identifier of the content.
e. The confirmation is done using the same connection that was dialed out by the sending fax.

5. (canceled)

6. (canceled)

7. The system of claim 6 wherein said communications are Fax transmission and in order to confirm that the receiver indeed received the Fax, the fax is sent through a trusted authority and at least one of the following features exists:
a. Said authority automatically sends back to the sender, by at least one of fax and email, a confirmation of at least one of the intended receiver's identity, the time and date the Fax was sent, and the content of the Fax.
b. The trusted authority forwards the Fax to the receiver and makes sure that the receiver indeed received the Fax.
c. The trusted authority continues to attempt sending the Fax again at least for a number of times and/or for a certain time, until normal conventional confirmation is received from the receiving machine that the transmission went through OK and/or until confirmation is received, and/or until too much time has elapsed and/or too many attempts have failed.
d. The trusted authority keeps a copy of the fax in the authority's database, which can be retrieved upon request also later if needed.

8. The system of claim 1 wherein in order to ensure the safety of private keys a hardware that contains the private keys contains also all the software or firmware for accessing and processing these keys, so that in order to digitally sign and encrypt a document, the document has to be sent to this hardware and processed by the hardware itself, so the returned output from the hardware is the already encrypted and signed document.

9. The system of claim 8 wherein at least one of the following features exist:
a. Said hardware also uses at least one incrementally changing element, which can be affected also by the exact time and date, in order to reduce the chance of replay.
b. Said hardware has a secure and/or encrypted channel for accessing at least one of the computer screen and the printer and/or has an output means of its own, in order to display to the user the correct unencrypted document that is being signed.
c. Each authorization can be used only once and must therefore be explicitly reapplied in order to sign an additional document.
d. Using the hardware requires also typing some password or secret code.
e. The hardware can indicate at least the File size and/or CRC and/or other fingerprints of the file that is being signed, and at least one of a security software and a function of the Operating system and the user checks if the parameters displayed by the hardware fits with the parameters displayed by the computer.
f. At least one of a security software and the Operating System ensures that the users always sees the correct real document on which he is digitally signing, by preventing any other software from accessing the hardware and/or the driver and/or software that come with the hardware without explicit permission by the user.

10. The system of claim 1 wherein said communications are email messages and in order to prevent faking of the sender's email and/or his IP address, at least one of the following features is used:
a. The mail server that receives the message from the user's computer can look at the “From” field and/or “reply-to” field of the e-mail message that the user is trying to send and refuse to relay the message if the “From field” indicates an email address who's corresponding IP address is beyond the range or list of allowed IP addresses for that server.
b. The mail server that receives the message from the user's computer checks if the given sender e-mail address actually exists at all.
c. Changing the e-mail protocol, so that each e-mail-sending program must use at least one of a random code and the exact time when the message was generated, and the email server immediately contacts back the sender and asks it to repeat the sent code and refuses to relay an e-mail message if the sender does not respond with the correct answer.
d. Physical/Geographical IP addresses are used and each server can instantly know if any IP address given by the user is real or not according the trace of its route, and thus refuse to communicate with a source that uses an IP address that is impossible according to its real position on the Internet.
e. The access provider and/or the e-mail server identify at least one of {the user's phone number, a unique identifier of the user's computer, a unique identifier of the user's communication card, the connection, and the IP address assigned to it for that connection} and therefore are able to prevent using a different IP address by the user's computer and/or using a stolen account by someone else.
f. The user has to explicitly notify the access provider of the sender email addresses that can be used from at least one of each uniquely identified computer and connection and phone numbers.
g. Each time a user's computer sends an email address or uses some IP address it is logged on the nearest access provider's node along with unique identifying data of the computer and/or the connection and/or the phone number used and/or the IP address that was assigned to this connection, and if the sender's email address changes more than a certain allowed number of times during that session then the offending messages can be blocked and/or logged.
h. The first server or node that the outgoing packets from the user's computer reaches first sends back a short package to the given source IP address and forwards the packets only if the machine at the given IP address confirms that it indeed initiated the outgoing packets.
i. Normal users that are not running servers are automatically marked by the access provider as end-node and thus attempts to pretend to be a server can be automatically ignored.
j. The mail server on the receiver's side verifies the IP of the sender's side server by contacting back the sender's side server, and even if the sending client can pretend to be a server, it doesn't help him since attempts to fake the IP address will not work.

11. The system of claim 1 wherein said communications are email messages and at least one of the following features exists:
a. Email servers or routers along the way are used for verifying the receipt of an email message.
b. At least the end-node email server or router that communicates directly with the final receiver can automatically send back a confirmation email to the sender if the email was received OK.
c. Confirmation can be sent also from relay servers or routers along the ways and not only the last one.

12. The system of claim 11 wherein said confirmation includes at least one of:
a. Sending back a digitally certified copy of the email message and/or at least part of it.
b. Sending back some serial number of the message.
c. Sending back a digital key.
d. Changing the email protocol so that the last server or router that communicates directly with the receiver can query the receiving node after sending the message and the receiving node either answers that it received it or that it didn't, and if no answer is received, the last sending node keeps trying at least for a certain number of times and/or a certain period.
e. The original server of the sender or any other server along the way can send the request for acknowledgement to the receiving node and wait for the confirmation.
f. The confirmation that the message was received OK by the receiving server includes sending also at least one CRC or fingerprint or size data together with the message from the sending server, so that the receiving server can confirm that the message came OK.
g. The receiving server also sends back to the sending server a copy of the message it received, so that the sending server can check if it is identical with the sent message.
h. A unique private key of the server prevents forgery of the receipt, so that knowing the secret key is required in order to be able to create the proper receipt at the given time and date.
i. Sending back a return key that includes also at least one of CRC and fingerprints that can be used for confirming that what the content was.
j. The server can save a copy of this CRC or CRCs or fingerprints at least upon request for at least a certain time period.

13. The system of claim 12 wherein said digital key is based on at least one of:
a. A unique identifier of the server or router.
b. The time and the date.
c. The serial number of the message.
d. At least one CRC and/or fingerprint that identifies the content of the message.

14. The system of claim 1 wherein said communications are email messages and a trusted authority is used, and no previous setting of account by the sender at the server is required, and each sender can use the services of the central authority by using a properly formed message, and said authority is used for confirming at least one of: The receipt of an email message, and The content of the message.

15. The system of claim 14 wherein said confirmation can be by at least one of:
a. A certified copy return from the authority with at least one of a stamp or signature.
b. In the form of a record kept at the authority for at least a few years, in case a later certificate is needed.
c. A stamped return FAX.
d. A digitally signed email.

16. (canceled)

17. The system of claim 14 wherein payments for the authority's services can be done by at least one of:
a. Adding an appropriate header to the message that includes at least one of credit card info and micro-payments credit points.
b. Payment later when the authority gets back to you.
c. Using a secure email protocol that contains unique parameters of the sender's computer or connection, in a way similar to a secure access to a web page.
d. Adding it automatically to the regular billing by the ISP.

18. The system of claim 1 wherein at least one of the following features exists:
a. The sender can use any official sender and/or “reply-to” e-mail address that he wishes, but must include also an additional field which shows the correct e-mail address which was actually used during the sending of the message.
b. A user can specify sender email addresses that belong to another domain on the internet if the mail server on the site allows legitimate users to define various e-mails and/or IP addresses that they might use when actually sending the messages, and in order to enable this, if the outgoing mail server finds that the sender address is not within the allowed range, it can still relay the message by verifying with a server on that domain that the actual sender address is listed there.
c. Digital signatures cannot be used from IP addresses that are outside a range or list of allowed IP addresses.
d. When a confirmation is sent back to the user by a trusted authority or by servers along the way, the party that sends the confirmation also at least one of: Confirms that the sender indeed received the confirmation, and Is able to send again the confirmation if the sender requests it.
e. A trusted authority is used, which forwards the message to the receiver, and if the receiver has not received the message the trusted authority continues to attempt sending the message again at least for a number of times and/or for a certain time.
f. A copy of the message is sent in parallel also to a trusted authority for keeping a log of the content without the need to route the message through the authority, if other methods are used to sufficiently ensure that the message indeed has been received by the receiver.
g. The sending email server also adds its own confirmation key and/or time and date stamps and/or serial number, so that these can be used by the receiver as a confirmation about the content of the message that was sent to him.
h. The sending Fax machine also automatically adds is own unique serial number and/or key that preferably reflects also a time and date stamp, so that the receiver also has a confirmation that the fax sent to him was authentic.
i. The phone company's computer automatically identifies if the connection is used for a normal voice communication or for electronic data connection or Fax transmission, and then at least one of the following is done: 1. If it is a data connection the phone company forwards the number to the ISP even if the user has normally a block on identified phone calls when he initiates a normal voice call. 2. If it is a Fax or similar kind of transmission the phone company forwards the number to the called number even if the user has normally a block on identified phone calls when he initiates a normal voice call.
j. The sending server keeps a record of messages that were sent out, containing at least the subject, sender and receiver, at least for a certain period, and the receiving server and/or the user's client email program can be instructed by the user to check once in a while if and when any messages were sent from a certain sender or list of senders to the user.
k. The fax machine can be connected to the user's computer in a way that causes it to send the images of the faxed pages directly into the computer so that it can be send directly by email, without having to add a fax card to the computer itself and an additional phone line.
l. The fax machine can be connected to the user's computer in a way that causes it to send the images of the faxed pages directly into the computer so that it can be send directly by email, without having to add a fax card to the computer itself and an additional phone line, and this connection is done by connecting the fax to the parallel port or to the USB and adding a function to the fax that allows the user to send the fax-coded images to the computer instead of over phone lines, or dialing a special number that activates this.
m. A trusted authority is used and said authority saves at least one CRC and/or at least one fingerprint of the message which can be used for proving what the content was, without having to save the full content itself.
n. A trusted authority is used and said authority charges a smaller amount for saving only the CRC's and/or other fingerprints of the content, and charges larger amount for saving the full content.

19. (canceled)

20. The system of claim 1 wherein at least some combination with conventional postal services are used and wherein a certified email message or Fax is automatically relayed to a post-office branch which is near to the receiver's Physical address, and is printed and hand-delivered from there like an ordinary certified mail.

21. The system of claim 20 wherein said near branch is found by at least one of:
a. Using IP addresses that contain also physical addresses.
b. Using the physical address of the receiver and automatically matching it with the near post office branch by at least one of country and city and zip code.

22. The system of claim 1 wherein at least some interchange is allowed between Fax and email messages, so that at least one of:
a. Certified communications can be sent to the trusted authority for as email messages and converted there to Fax communications with the receiver.
b. Certified communications can be sent to the trusted authority as Fax messages and converted there to email communications with the receiver.

23. The system of claim 1 wherein at least one of the options of receipt-verification is used when at least one of:
a. The user specifically requests certified communications.
b. Automatically even without requesting it.
c. Automatically for basic verification and based on user request for more intensive verification.
d. Automatically for basic verification and based on user request for more intensive verification, wherein said basic verification includes sending back from the last server that communicates directly with the receiver at least a confirmation serial number and/or time and date stamp and/or digital key.

24-50. (canceled)

51. The system of claim 1 wherein the mail server at the side of the receiver can inform the mail server at the side of the sender, and/or the sender directly, if and when the receiver actually accessed the mail, by at least one of the following means:
a. Sending a confirmation when the email client program actually downloads the message from the mail server at the side of the receiver.
b. Keeping a log of said confirmation, at least for a certain period in order to enable the sender to request a copy of the confirmation also at a later time.
c. At least one of a trusted authority, the mail server at the side of the receiver, and the sending mail server, encrypts the mail and sends in to the receiver and when the receiver wants to read the message, the opening key is download from the relevant server, thus confirming actual receipt, and said downloading is done when the message is received by the client program or when the user opens the message.
d. The server saves at least also one or more fingerprints of the content and can send it back to the sender upon request.
e. The email protocol is changed so that the receiving mail server has to send some kind of acknowledgement to the sending server any time during the transmission of a message before the transmission is considered complete.
f. The sender and/or the sending server can also query the receiving mail server if the message has been downloaded by the receiver's client program.
g. The sending mail server and/or the receiving mail server automatically add an HTML code to the message that when executed makes the client mail program immediately connect to some address on the mail server, thus automatically confirming that the message has been opened.

52. (canceled)

53. The system of claim 51 wherein at least one of the following features exists:
a. If the receiving mail server is on a computer where the user gets the mail directly through logging in or through a mailbox web service, the receiving mail server informs the sender and/or the sending mail server that the message has been forwarded to the receiver at the moment that the servers adds the message to the user's messages Box.
b. The software that allows the user to access the message also sends a confirmation to the server when the user actually opens the mail message.
c. A resident software or driver ensures that the server is informed whenever the message is accessed, so that tempering with the client software cannot prevent notifying the server.
d. There is also a separate indication—if the user saw the header of the message even if he didn't open it, which is sent to the sender and/or to the sending mail server.

54. (canceled)

55. An email system wherein the user can instruct the receiving server and/or his email client to mark more conspicuously and/or put in a separate list all the emails from a list of senders which the user marks as preferred and/or this group can be generated automatically by putting in the list all the emails to which the user himself sent messages and/or they are automatically given a higher position if the user sent more messages to them.

56. (canceled)

57. The system of claim 1 wherein in public-use computers the OS itself and/or a security software enables the administrator to specify that this is a public-use computer, and at least one of the following features exist:
a. This setting can be changed only with the original installation disk and/or with a password and/or with some other physical key.
b. When defined as a public computer, the OS and/or the security software indicates this in outgoing electronic communications.
c. Any session-related traces are automatically removed by the system after a short time of inactivity and/or if the user does not re-enter a password chosen by the original person that started the session, or such traces are not saved at all.
d. The OS and/or the security software allows the user to send additional email messages from the same session only if he know the password entered or chosen by the user when he started the session, etc.

58. (canceled)

59. (canceled)
